(19) United States
(12) Patent Application Publication
(10) Pub. No.: US 2025/0308247 A1
(43) Pub. Date: Oct. 2, 2025

(54) DATASET GENERATION FROM SCENARIOS CLUSTERED BY SCENE SIMILARITY

(71) Applicant: Zoox, Inc., Foster City, CA (US)

(72) Inventors: Ruitao Yi, Santa Clara, CA (US); Mahsa Ghafarianzadeh, San Francisco, CA (US); Kenneth Michael Siebert, Redwood City, CA (US); Arunava Basu, Redwood City, CA (US); Archie Lee, San Francisco, CA (US)

(21) Appl. No.: 18/622,658

(22) Filed: Mar. 29, 2024

(51) Int. Cl. G06V 20/58; G06V 10/762

(52) U.S. Cl. CPC G06V 20/58; G06V 10/762

(57) ABSTRACT

Techniques are described for clustering scenes based on a scene representation that captures aggregated information related to the scene including objects in the scene, object trajectories, interactions between objects, and map data. Example scene representations may include aggregated labels in spatial bins relative to a driven trajectory of an autonomous vehicle, feature vectors describing a sequence of poses of objects over time and interactions between objects and the autonomous vehicle over time, and scene representations comprising embeddings from trained machine-learned prediction models. The scene may also be assigned a difficulty level based on a prediction accuracy of the prediction models when provided the scene as an input. The clustered scenes may be sampled for generating a dataset meeting specified criteria. For example, the dataset suitable for training a ML model may be generated that maintains a diversity of scenarios while avoiding repetition of common scenarios.

### BACKGROUND

An autonomous vehicle may use machine-learned models in various components of the vehicle, such as components for perceiving an environment through which the vehicle traverses, for predicting behaviors and motion trajectories of objects in the environment, planning a trajectory through the environment, and the like. Training the machine-learned models may require training datasets that provide examples of various scenarios that may be encountered by the vehicle during operations. However, datasets providing example driving scenarios can have an enormous amount of data instances (e.g., millions of data instances, or the like), many of which may be similar to each other or relatively common. In order for a machine-learned model to perform well in various real-life scenarios, the training dataset needs to include diverse example scenarios, including data instances covering example scenarios that occur relatively rarely.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 includes textual and visual flowcharts to illustrate an example method for generating a dataset from scenes illustrating various scenarios encountered while an autonomous vehicle navigates an environment, as described herein.

FIG. 2 illustrates examples of scene descriptions of a scene containing various objects.

FIG. 3 illustrates another example of a scene description of a scene containing various objects.

FIG. 4 depict example block diagrams illustrating yet another scene description of a scene using embedding spaces.

FIG. 5 depicts a block diagram of an example system for implementing the techniques described herein.

FIG. 6 depicts an example process for generating a dataset for training a machine-learned model, in accordance with examples of the disclosure.

### DETAILED DESCRIPTION

An autonomous vehicle system may use trained machine-learned (ML) models to detect and/or predict behaviors, characteristics, and/or motion trajectories of one or more objects in an environment a vehicle is traversing. Examples of objects may include dynamic objects such as vehicles, pedestrians, cyclists, as well as temporarily stationary objects such as parked vehicles, vehicles stopped at traffic lights, pedestrians waiting at crossings, etc. In some examples, the ML models may be trained using training datasets comprising data instances or scenes illustrating example driving scenarios. The scenes may be collected by autonomous vehicle(s) traveling in various environments (e.g., a scene may be log data generated by the vehicle that may include sensor data, perception data, prediction data, and/or the like), may be generated via simulations in a virtual environment, and/or may be generated by generative ML model(s) based on input prompts. Each scene may include objects in an environment, trajectories of the objects during a period of time, map features (e.g., indicating roadway, turn lanes, shoulder lanes, crosswalks, traffic lights, etc.), a geographical area or geo-fenced area, and/or features of the environment (e.g., status of traffic light, speed limit, weather conditions, etc.).

In examples of the present disclosure, the ML models may be trained more efficiently e.g., requiring less computing resources, less training time, producing smaller trained models, or the like, by providing a balanced training dataset that includes a diverse set of example scenarios while reducing repetition of common scenarios. The techniques discussed herein may reduce time, computational complexity, and effort needed to assemble such balanced training datasets by identifying scenes that are similar (e.g., illustrate similar driving scenarios), based on representations of the scenes that capture aggregate properties of the scene, as described below. The techniques discussed herein may also improve access to relevant scenes for applications such as testing, debugging, and validation of components of the autonomous vehicle, by enabling indexing and search of scenes by scene similarity and/or characteristics.

In examples, the techniques (e.g., machine(s), process(es), hardware and/or software, ML model(s), etc.) may determine a scene description for a scene. The scene description may aggregate meaningful information contained in the scene, such as, for example, behavior of objects in the scene, behavior of the autonomous vehicle, interactions between the objects and the autonomous vehicle, map information related to a geographic location of the scene, and the like. In examples, the scene descriptions described herein may be used to measure similarity between scenes e.g., a distance metric may be defined between scene descriptions that maps scene descriptions of similar scenes to smaller distances and scene descriptions of dissimilar scenes to greater distances in a scene feature space.

In an example scene description described herein, maneuvers of up to each object in a scene, including the autonomous vehicle, may be represented by a sequence of poses of the object over a time period. For example, the poses of an object at prior time instances (e.g., T−1, T−2, . . . ; i.e., historical data) and/or future time instances (e.g., T+1, T+2, . . . ; i.e., predicted data) may be specified relative to a reference frame of the object at time, T. As an example, the poses of the object may be specified from T−2 seconds to T+8 seconds with a step size of 1 second, each pose being represented by a feature vector comprising (x, y) or (x, y, z) coordinates along with one or more of yaw, pitch, or roll. The feature vector at each time instance may also include additional information such as a type of environment where the object is located (e.g., driving lane, parking spot, crosswalk, turn lane, etc.), geographic location or map data identifying a geographical area, an event associated with the time instance (e.g., accident, deployment of vehicle safety systems, near-miss, etc.), and the like. It is to be noted that the techniques described herein may be applied on data instances or scenes that have already been collected, and, as a result, they may include information on poses (i.e., positions and/or orientations) of objects both at time instances prior to, as well as after, a given time instance T.

Such a scene description may also include interactions of each object with the autonomous vehicle. An interaction between an object and the autonomous vehicle may also be represented as a sequence of poses, comprising the poses of the object relative to the autonomous vehicle (e.g., sampled every second between a T−2, . . . , T+8), both sequences of poses can be expressed relative to a reference frame of the autonomous vehicle at time T. The scene description may comprise a concatenation of the sequence of poses of the objects in the scene and/or a concatenation of the sequence of poses representing interactions between the objects and the autonomous vehicle.

In some examples, the scene description may only include object poses and/or interactions for a subset of objects in the scene. For example, objects may be excluded from the subset based on a distance from the autonomous vehicle (e.g., objects further than a threshold distance away may be excluded), speed of the object (e.g., stationary objects may be excluded), orientation of the object with respect to the autonomous vehicle (e.g., objects going away from the autonomous vehicle may be excluded), map information (e.g., objects in non-adjacent driving lanes may be excluded), or the like.

In some examples, a dimensionality reduction technique, such as Principal Component Analysis (PCA), a transformer-based encoder, t-distributed Stochastic Neighbor Embedding (t-SNE), linear discriminant analysis (LDA), and/or the like, may be applied to the scene description to reduce dimensionality, resulting in a scene description of smaller size. For example, a scene feature vector comprising a concatenation of feature vectors corresponding to the sequence of poses of the objects and/or interactions may be transformed into a final scene vector of reduced dimensionality, the scene description comprising the final scene vector of reduced dimensionality.

Another example scene description, as described herein, may utilize labels applied to objects and elements of the scene, as described in U.S. patent application Ser. No. 18/138,645 filed Apr. 24, 2023 titled “Dataset generation from clustered scenarios for balanced machine-learned model training,” the entirety of which is incorporated by reference herein for all purposes. For example, scenes may be labeled with various attributes such as classifications of the objects (e.g., pedestrians, vehicles, cyclists, etc.), maneuvers of the objects (e.g., changing lane, turning left, turning right, making U-turn, parking, crossing the road, stopping, etc.), a maneuver of the autonomous vehicle (e.g., changing lane, turning left, turning right, moving forward, parking, etc.), a status associated with the object or the autonomous vehicle (e.g., a location, a velocity level, a heading direction, yaw, pitch, and roll rates, etc.), environmental attributes (e.g., road conditions, weather conditions, traffic conditions, etc.), signage state (e.g., red light, passing permitted, lane closed, etc.), or the like.

In examples, a scene may be divided into spatial bins positioned relative to a driven trajectory of the autonomous vehicle in the scene. For example, the spatial bins may have a longitudinal direction along a planned or driven trajectory of the vehicle and/or relative to a position of the vehicle, and a latitudinal direction laterally offset from the trajectory and/or the position of the vehicle. In some examples, a size of the spatial bin along the longitudinal and latitudinal direction may be based on overall characteristics of the scene (e.g., speed at which the autonomous vehicle is traveling, number/density of objects in the scene, width of lanes, complexity of traffic flow) and/or features within an area covered by the spatial bin (e.g., number/density of objects in the spatial bin, classification of objects, relative orientation of a spatial bin to the autonomous vehicle, distance of the spatial bin from the autonomous vehicle). The size and/or shape of the spatial bins covering the scene may vary based on localized features within the area covered by the respective spatial bin.

In examples, such a scene description may aggregate, within each spatial bin, the labels applied to the scene. For example, the example scene description may comprise a set of feature vectors representing the spatial bins, where a feature vector corresponding to a spatial bin may indicate a presence or absence of each label in the respective spatial bin. For example, the feature vector corresponding to a spatial bin may be a one-dimensional vector of length equal to a number of possible labels. In such an example, a number at a position in the feature vector may indicate that the that number of labels present in the spatial bin, and a 0 may indicate that the label corresponding to the position is not present in the spatial bin. Additionally or alternatively, the feature vector may include a one-hot vector that indicates whether a label is or is not present within a spatial bin. In some examples, the labels may be grouped into types such as maneuver type, velocity type, type of object, and the like, and only one label in each group may be set to 1 following precedence rules (e.g., if velocity types “Slow” and “Medium Speed” are both present, the type indicating the higher velocity may be set to 1). In other examples, multiple labels may be set to 1 in each group (e.g., each maneuver type that is present may be set to 1). A dimensionality reduction technique, as described above, may also be applied to the scene description to reduce dimensionality of the feature vectors.

In some examples, the example scene description may include a natural language summary of the scene based on the labels present. For example, the labels present and/or their relative positions based on the spatial bins where they occur, may be provided as input to a language model trained to output descriptive text in response to the labels. Such descriptive text may be used for enabling natural language queries to search for examples of particular scenarios e.g., “A car is making a right turn on red light,” “A pedestrian is waiting at the crosswalk,” etc.

In some examples, the example scene descriptions described above may be combined to generate a scene description including more than one type of descriptors. For example, an extent of the spatial bins as well as locations of the poses may both be specified with respect to coordinates of a map (e.g., map data), allowing for determination of correspondence between the spatial bins and the poses of the objects. In such an example, labels associated with a spatial bin may be added to feature vectors corresponding to the poses falling within an extent of the spatial bin to generate a combined scene description based on both techniques.

In examples, large-scale machine-learned (ML) prediction models trained on very large training datasets of input scenes (e.g., millions of scenes) may be available for testing and validation of ML-based autonomous vehicle components. Such large-scale ML models may be “offline” models, e.g., separate from ML models deployed on-board the autonomous vehicle, which may comprise quantized models or less computationally intensive model architectures based on limitations of computing resources on-board the vehicle. Further, training data used to train such offline models may include both data from time instances prior to, or after (e.g., in future time), relative to a given time instance. After training, the ML prediction models may learn an internal representation of input scenes that captures information needed for predicting object behaviors or determining a trajectory for the autonomous vehicle. For example, encoder components of the ML models may project the input scene to an embedding in an embedding space that captures similarities between scenes. Such an embedding may be functionally analogous to information contained in the scene descriptions discussed above e.g., by capturing aggregated information about an input scene and objects in the scene. Increasing distance between two embeddings in the embedding space may indicate increasing dissimilarity between the scene descriptions for the two embeddings.

In yet another example described herein, a scene description may comprise one or more embeddings generated by trained large-scale ML prediction model(s). An example of a transformer-based ML model for prediction that captures scene and object information as embeddings, is described in U.S. patent application Ser. No. 18/227,813 filed Jul. 28, 2023, the entirety of which is incorporated by reference herein for all purposes. Further, a transformer-based ML model for prediction that also captures relative positions between objects and the autonomous vehicle is described in U.S. patent application Ser. No. 18/423,182 filed Jan. 25, 2024, the entirety of which is incorporated by reference herein for all purposes. In examples, a scene may be provided as input to an input encoder component of the transformer-based ML model which has been trained on input scenes in similar format. The embedding (e.g., a high-dimensional vector or tensor) generated by the encoder component represents the input scene in an embedding space. The scene description may comprise such an embedding, as generated by a trained ML prediction model.

In some examples, a scene may be represented by multiple inputs, such as a top-down view, map data corresponding to the scene, sensor data corresponding to the scene, and the like. A trained transformer-based ML model may include separate encoder components for each type of input, generating embeddings in separate embedding spaces. In such an example, the scene description may comprise a combination (e.g., a concatenation, an average, an embedding determined by a multi-layer perceptron that determines the embedding using the input embeddings) of the embeddings generated by the separate encoder components. As an example, U.S. patent application Ser. No. 18/304,975 filed Apr. 21, 2023, which is herein incorporated by reference in its entirety for all purposes, describes a transformer-based model that generates embeddings of image data, lidar data, and map data in respective embedding spaces.

In some examples, the trained large-scale ML prediction model(s) may be based on a graph neural network (GNN) architecture where objects are represented by nodes of the GNN. The trained GNN may capture an object's behavior as a node embedding. Further, an interaction embedding may capture interactions between objects. The scene description may alternatively, or in addition, comprise the node embeddings and/or interaction embeddings from a GNN trained for prediction of object behaviors. In some examples, one or more of the different types of scene descriptors described above may be used to represent a scene, the scene description including a combination of different types of scene descriptors.

In some examples, a difficulty level may be determined for each scene. For example, the difficulty level of a scene may be based on performance of a trained ML prediction model when provided the corresponding scene description as input. As an example, if a prediction component of the autonomous vehicle can predict future poses of objects in a scene with high accuracy (e.g., with low error), then the scene may be assigned a low difficulty level indicating that the autonomous vehicle systems perform accurately in the scene. Whereas, if the prediction component generates relatively large error(s) in predicting future poses of one or more of the objects in the scene, the scene may be assigned a higher degree of difficulty. In some examples, a discrete number of difficulty levels may be defined, each corresponding to a threshold error level of prediction. In some examples, the error may be determined based at least in part on determining a difference between a prediction of a future object state generated at a first time to a detected object state at that future time once it has come to pass.

In examples, scenes may be clustered by similarity of scene descriptions. For example, a distance metric (e.g., cosine distance, Manhattan distance, Minkowski distance, Euclidean distance, etc.) between the scene descriptions may be defined such that a shorter distance between scene descriptions indicate higher similarity. In some examples, the distance metric used for clustering may be based on an output of a machine-learned (ML) model trained on scene feature vectors corresponding to similar and non-similar scenes. As a non-limiting example, k-means clustering may be used to determine scene clusters based on similarity of scene descriptions. However, various other clustering techniques may also be used e.g., k-medians, agglomerative, expectation maximization (EM), hierarchical clustering, density-based clustering (e.g., density-based spatial clustering of applications with noise (DBSCAN)), etc.

In some examples, a visualization of the scene clusters may be provided through a user interface, which may comprise using uniform manifold approximation and projection (UMAP) to reduce the embedding space and representations of clusters to two or three dimensions, which may be more suitable for presentation via a display, augmented reality display, or virtual reality display. The user interface may enable searching and browsing of the scene clusters, including providing constraints such as searching within areas of interest such as within a specific geographical area, urban scenes in specific cities, areas of high traffic accidents, and the like. Such a user interface may allow a user to locate scenes for use in testing, debugging and/or validation of components of the autonomous vehicle in scenarios of interest and/or assign tags to the scene clusters at a cluster-level and/or at a scene level. In some examples, a dimensionality reduction technique, such as t-distributed Stochastic Neighbor Embedding (t-SNE) or UMAP may be applied to the scene descriptions to map each scene description to a 2D or 3D space suitable for visualization e.g., as a scatter plot, where scene clusters may be indicated by color-coding.

In examples, a dataset may be generated by sampling the scene clusters. For example, the scene clusters may be sub-sampled to select a smaller subset of representative data instances, while maintaining a diversity of scenarios represented in the dataset. The sub-sampling fraction may be based on a target dataset size provided as input e.g., the target dataset size may specify a maximum storage amount in gigabytes, a maximum training time, a maximum computational processing capacity, and/or a total number of data instances in the target dataset. In some examples, the sub-sampling fraction may be computed by dividing the target dataset size by the total size of data instances in the scene clusters, and the scene clusters may be sampled uniformly based on the fraction. In additional or alternate examples, a maximum available computational processing capacity, maximum storage/memory, and/or maximum training time may be used to determine the target data set size based at least in part on an estimated computational load, storage/memory size of the dataset (e.g., at rest in storage, in use in computation), an estimated computation time, and/or the like.

In some examples, the scene clusters may be sampled based on the difficulty level and or a rareness score assigned to each scene of the scene cluster e.g., scenes with higher difficulty level may be selected ahead of scenes with lower difficulty level when sub-sampling the cluster or sampled at a higher rate than lower difficulty scenes. In some example, the difficulty level or rareness score may be associated with the cluster, and a higher fraction may be assigned to a cluster with a higher difficulty level during sub-sampling. For example, difficulty level of the cluster may indicate how hard it is for an autonomous vehicle to maneuver safely in the scenario represented by the cluster e.g., a driving scene with multiple objects close to the autonomous vehicle, or a road section with multiple turn lanes, may be assigned a higher difficulty level. In some examples, the difficulty level associated with a cluster may be determined based on a distance of the cluster center from one or more neighboring clusters e.g., clusters with a higher distance from their respective nearest neighbors may have higher difficulty levels. A difficulty level may also be based on a number of members within a cluster (e.g., a cluster with fewer members may indicate a rare event that may be more difficult). Additionally or alternatively, previous performance of the vehicle in a scene (e.g., whether a real-world vehicle or a simulated vehicle performance) may be used to determine the difficulty. The clusters may be sub-sampled based on the difficulty level of the cluster e.g., more samples may be selected from clusters with a higher difficulty level.

Alternatively, or additionally, a combination of constraints may be used to generate the dataset. For example, different percentages of the dataset may be based on different criteria e.g., 90% may be based on uniform sub-sampling, and 10% may be based on selecting data instances with the highest difficulty level within each cluster. As another example, 60% of the dataset may be selected from clusters based on similarity of scene labels, and 40% of the dataset may be selected from clusters based on similarity in an embedding space. As yet another example, 50% of the dataset may be selected by random sampling, and 50% of the dataset may be selected based on highest distance from the centroid of respective clusters.

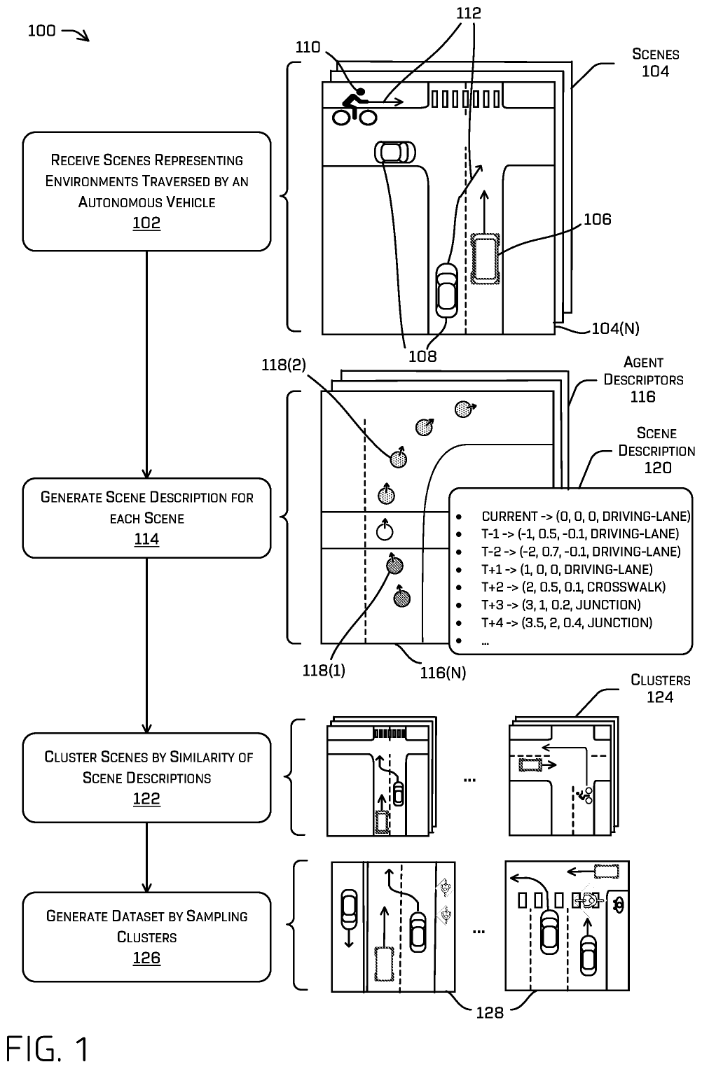

The techniques described herein can be implemented in a number of ways. Example implementations are provided below with reference to the following figures, FIGS. 1-6. Although discussed in the context of an autonomous vehicle, the methods, apparatuses, and systems described herein can be applied to a variety of systems (e.g., a sensor system or a robotic platform), and is not limited to autonomous vehicles. In another example, the techniques can be utilized in an aviation or nautical context, or in any system using machine-learned (ML) models that require training datasets capturing a diversity of input scenarios. Additionally, the techniques described herein can be used with real data (e.g., captured using sensor(s)), simulated data (e.g., generated by a simulator), machine-generated data (e.g., generated by a generative ML model), or any combination of such data.

FIG. 1 includes textual and visual flowcharts to illustrate an example process 100 for generating a dataset from a large number of scenes illustrating various driving scenarios. The datasets may be used for training machine-learned (ML) models related to autonomous driving functions such as perception of an environment based on sensor data, prediction of behaviors of objects in the environment, planning a trajectory for autonomous driving, and the like. In some examples, the datasets may also be used for debugging autonomous vehicle behavior e.g., in a specific driving scenario or a challenging locale. The techniques described herein may also be used for enabling searching the large number of scenes to find scenes similar to a query scene based on scene similarity, for automatically transferring human-generated labels to other similar scenes, verifying that a sufficient number of examples exist for a given scenario, and the like. In some examples, the techniques may also enable an autonomous vehicle system to maintain awareness of the number of similar/different scenarios it has encountered (e.g., through introspection).

In some examples, the datasets may be used for training ML models that are deployed on an on-board autonomous vehicle computing system. For example, such a ML model may be an online model that receives sensor data and other data during operations of the autonomous vehicle and generates predicted outputs that are used by the autonomous vehicle in real time for navigating its environment. In examples, the process 100 may be implemented on a remote computing system(s) which may be separate from the autonomous vehicle computing system, and may include more computing resources (e.g., larger number of processors, processors with higher capabilities, larger memory, and/or specialized high-speed memory) than the on-board vehicle computing system.

At an operation 102, the process 100 includes receiving scenes representing environments traversed by an autonomous vehicle. In some examples of this disclosure, scenes 104 may refer to top-down representations generated from sensor data captured by actual sensors in the real world. In some examples, the top-down representation may be generated from physics-based modeling and simulation in a virtual environment. In some examples, the top-down representations may comprise or may be based on machine-generated images output by generative ML model(s) based on inputs which may include other images, text prompts, metadata, and/or other information guiding an output of the generative ML model(s). Techniques for determining a top-down representation of the environment based at least in part on the sensor data, are discussed in U.S. Patent Application Pub. No. 2021/0181758, filed Jan. 30, 2020, and/or U.S. Pat. No. 10,649,459, issued on Apr. 26, 2018, the entirety of which are incorporated by reference herein for all purposes. For example, the top-down representation may be generated based at least in part on an object detection by a perception component of the autonomous vehicle system and/or map data of a geo-location in the environment.

In some examples, the scenes 104 may represent driving scenarios obtained from log data collected by autonomous vehicles during data collection or regular operations, or simulations of autonomous vehicles in virtual environments. Example methods for determining driving scenarios from log data are described in U.S. patent application Ser. No. 18/138,645 filed Apr. 24, 2023 which is incorporated by reference, as noted above. Additionally, though a top-down representation is used as an example, the scenes 104 may comprise other representations of driving scenarios e.g., images from other viewpoints or data in other formats.

As shown in FIG. 1, an example scene 104(n), of the scenes 104, illustrates multiple objects, such as an autonomous vehicle 106, other vehicles 108, and a bicycle 110, traversing an environment. The scene 104(n) may include additional information, such as trajectories 112 of the objects, map data associated with a geographical area of the environment, source of the scene 104(n), sensor data captured at the scene 104(n), and the like. The additional information may be included in log data associated with the scene 104(n). In some examples, the scenes 104 may include positions of objects in each scene 104(n) as a series of ticks of data ordered in time and separated by periods of time such as 0.1 seconds, 0.5 seconds, 1 second, or the like, where a tick of data may include instantaneous positions of objects in the environment at the given time. It is to be noted that the scenes 104 have already been collected, and as a result, they include information on poses (i.e., positions and/or orientations) of objects both at time instances prior to, as well as after, a given time instance.

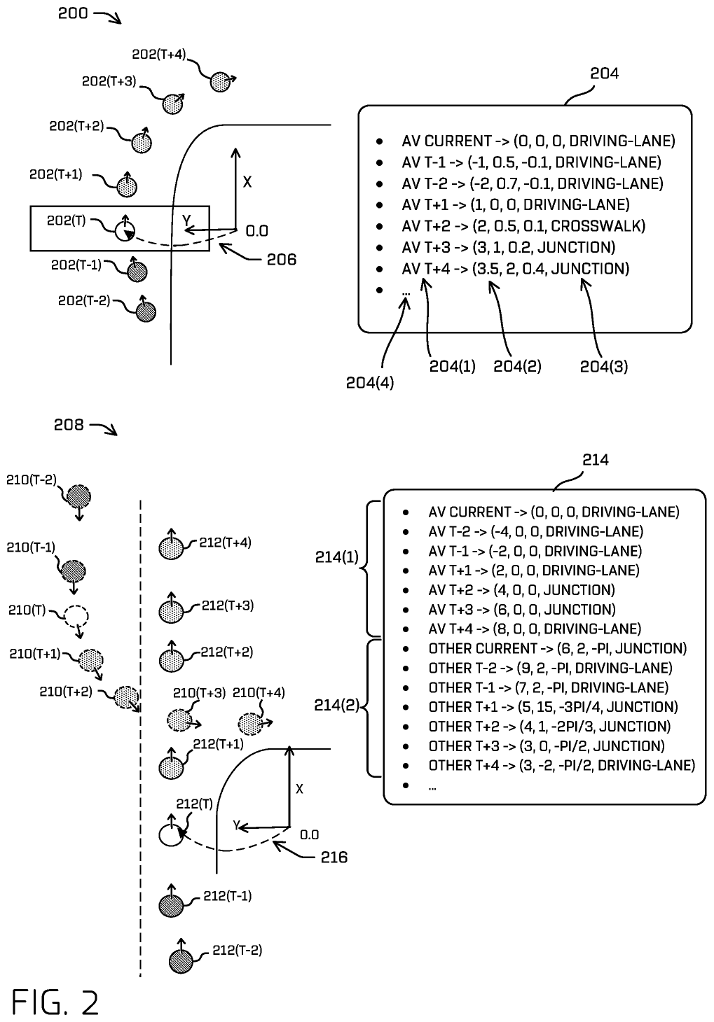

At an operation 114, the process 100 may include generating a scene description for each scene of the scenes 104. The scene description may capture aggregated properties of the scene, including objects in the scene, interactions between objects, map information, object behaviors, features of the environment, and the like. Various techniques for capturing aggregated properties of the scene are described herein, with reference to FIGS. 2-4. In an example shown in FIG. 1, agent descriptors 116 for each object in the scene may capture behavior of the respective object over time. For example, an agent descriptor 116(n) may indicate a sequence of positions (e.g., x-, y-, and/or z-coordinates in a 2D or 3D coordinate system), an orientation (e.g., a yaw/heading), and/or a velocity of an object (e.g., vehicle 106) in the scene 104(n), including a pose at time T (shown unshaded), prior poses (e.g., pose 118(1)) or future poses (e.g., pose 118(2)). In such an example, the process 100 may generate a scene description 120 comprising a scene feature vector that is a concatenation of feature vectors corresponding to all objects of interest in the scene. The feature vectors may represent the sequence of poses of the objects and/or additional map information. The scene description 120 may also include feature vectors representing interactions between the objects in the scene feature vector, as described in further detail with reference to FIG. 2.

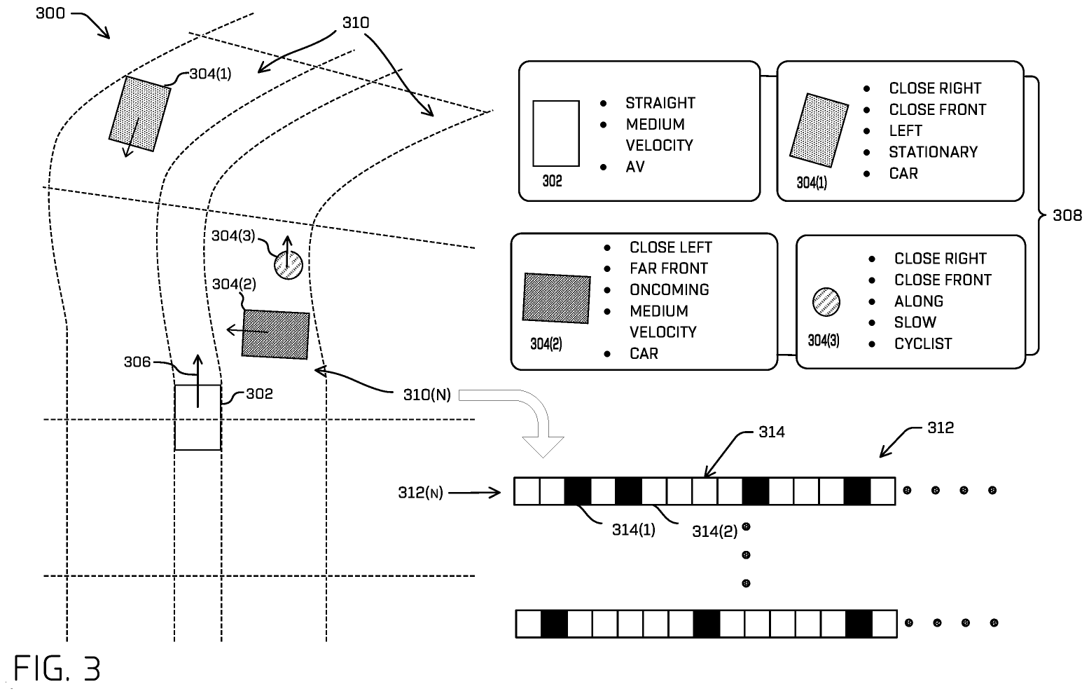

As another example, additionally or alternatively, the scene description 120 may be based on aggregating, in spatial bins, labels applied to elements of the scene. For example, U.S. patent application Ser. No. 18/138,645 filed Apr. 24, 2023, which has been incorporated by reference, as noted above, describes scene labels indicating types of maneuvers and interactions in the scene, types of objects in the scene, map feature associated with the scene (e.g., crosswalk, traffic light, junction, etc.), and the like. The scene description 120 may include an aggregation of such labels in spatial bins. For example, the scene description 120 may comprise a concatenation of one-dimensional vectors for each spatial bin, where each cell of the vector corresponds to a label, and a non-zero cell value indicates presence of the corresponding label in the spatial bin, as described in detail with reference to FIG. 3.

As yet another example, additionally or alternatively, the scene description 120 may comprise embeddings in a high-dimensional space obtained from transformer-based ML model(s) trained for performing prediction tasks. For example, the transformer-based ML model(s) may be trained to predict future poses of objects in the scene based on an input scene. Such transformer-based ML model(s) may learn embedding(s) representing the input scene capturing information relevant to the prediction task. This information may be functionally analogous to a scene description based on agent descriptors and/or labels as discussed above, as the embedding space captures similarities between situations of objects across scenes. The process 100 may provide the scenes 104 as inputs to an encoder component of the trained transformer-based ML model, and use the embedding returned by the encoder component as the scene description 120 for the corresponding scene. Examples of transformer-based ML models for prediction that capture scene and object information as embeddings, is described in U.S. patent application Ser. No. 18/227,813 filed Jul. 28, 2023, which is incorporated by reference, as noted above.

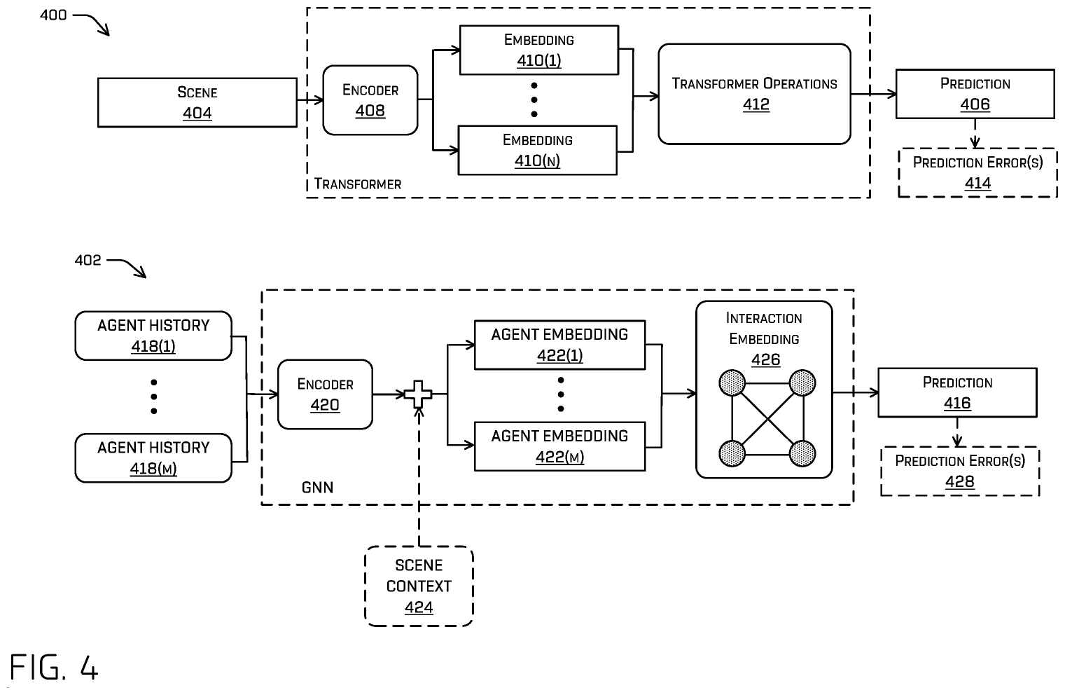

As another example, graph neural networks (GNNs) may be used to predict behavior of objects in the scene, where each node may correspond to an object. A loss function used in training the GNNs may encourage similar nodes to map to node embeddings that are close together and dissimilar nodes to map to node embeddings that are farther apart in an embedding space. In some examples, the process 100 may use the node embeddings of GNNs trained for prediction of object behavior as the scene description 120. Scene description based on embeddings is described in further detail with reference to FIG. 4.

In some examples, the operation 114 may include applying a dimensionality reduction technique, such as Principal Component Analysis (PCA), Uniform Manifold Approximation and Projection (UMAP), t-SNE, Linear Discriminant Analysis (LDA), and the like, to reduce dimensionality of the scene description 120. For example, the scene feature vector comprising a concatenation of feature vectors corresponding to the objects may be transformed into the scene description 120 of reduced dimensionality.

In some examples, at the operation 114, the process 100 may generate the scene description 120 by applying more than one of the techniques described with reference to FIGS. 2-4, the scene description 120 including different types of descriptions each based on a respective scene description technique. As an example, the scene description 120 may include a description based on aggregation of labels within spatial bins, as described with reference to FIG. 3, and embeddings as described with reference to FIG. 4. As another example, the scene description 120 may include aggregation of labels within spatial bins, as described with reference to FIG. 3, and the scene description illustrated in FIG. 1. In such examples, the labels may provide a human-interpretable description of the scene 104(n).

At an operation 122, the process 100 may include clustering scenes by similarity of scene descriptions. As discussed, at the operation 114, the process 100 generates the scene descriptions (such as the scene description 120) for the scenes 104. The scene feature vectors of the scene descriptions may be clustered by similarity to generate clusters 124 of scenes based on a defined distance metric (e.g., cosine distance, Manhattan distance, Minkowski distance, Euclidean distance, etc.) between the scene feature vectors e.g., a shorter distance between two scene feature vectors may indicate higher similarity. In some examples, the distance between scene feature vectors may be based on geolocation and/or content of the scene (e.g., type of maneuver, particular scenario, scene labels, etc.). In examples where the scene descriptions include descriptors of different types, each type may be weighted differently during computation of distance between the scene descriptions. For example, a scene descriptor using embeddings may be weighted differently from a scene descriptor using scene labels. In some examples, the distance metric used for clustering may be based on an output of a machine-learned (ML) model trained on scene feature vectors corresponding to similar and non-similar scenes. As a non-limiting example, the process 100 may use k-means clustering at the operation 122. Various other clustering techniques may also be used to determine clusters based on the distances between the scene feature vectors or density of scene feature vectors (e.g., k-medians, agglomerative, expectation maximization (EM), hierarchical clustering, DBSCAN).

In some examples, the process 100 may provide a visualization of the clusters 124 through a user interface. The user interface may enable searching and browsing of the clusters 124 by similarity, including providing constraints such as searching within areas of interest such as within a specific geographical area, urban scenes in specific cities, areas of high traffic accidents, and the like. Such a user interface may allow a user to locate scenes for use in testing, debugging and/or validation of components of the autonomous vehicle in scenarios of interest and/or assign tags to the clusters 124 at a cluster-level and/or at a scene level. In some examples, a dimensionality reduction technique, such as t-distributed Stochastic Neighbor Embedding (t-SNE) may be applied to the scene descriptions to map each scene description to a 2D or 3D space suitable for visualization e.g., as a scatter plot, where scene clusters may be indicated by assigning a different color or icon to a point representing a scene from each scene cluster.

As discussed, in some examples, the scene descriptions may include different types of descriptions based on more than one techniques. In some examples, the process 100 may cluster scenes by similarity using a first type of description included in the scene descriptions, and provide information obtained from a second type of description associated with the clusters 124. For example, the first type of description may use embeddings, and the second type of description may be based on labels aggregated within spatial bins. In such examples, the labels may provide a human-readable interpretation of the clusters 124 formed based on similarity in an embedding space. In some examples, such labels may be provided as a part of the visualization of the clusters 124 through the user interface.

At an operation 126, the process 100 may include generating a dataset by sampling the clusters 124. The process 100 may sub-sample the clusters 124 to select a smaller subset 128 of representative data instances to include in the dataset. The process 100 may aim to reduce data volume while maintaining a diversity of scenarios represented in the dataset. For example, each cluster of clusters 124 may include a large number of examples scenarios (e.g., millions of instances) that are similar, and the process 100 may sub-sample the cluster to reduce repetition of the same scenario e.g., a fraction of the cluster may be retained in the dataset. In some examples, sub-sampling may reduce the number of samples by a factor or 2 or more. The sub-sampling fraction may be based on a target dataset size provided to the process 100 as input e.g., the target dataset size may specify a maximum storage amount in gigabytes and/or a total number of data instances in the target dataset. In some examples, the process 100 may compute the fraction by dividing the target dataset size by the total size of data instances in the clusters 124, and sample the clusters 124 uniformly based on the fraction.

In some examples, the process 100 may generate the smaller subset 128 of data instances by sub-sampling the clusters 124 randomly e.g., data instances from each cluster of the clusters 124 may be selected randomly. In some other examples, data instances of the clusters 124 may be ordered by a distance from a centroid of the respective cluster, and the process 100 may generate the smaller subset 128 by selecting data instances in a decreasing order of their distance from the centroid e.g., data instances with the highest distance may be selected first, as these instances may capture rarer scenarios. In some examples, the clusters 124 may be sampled based on a difficulty level and or a rareness score assigned to each data instance of the cluster e.g., data instances with higher difficulty level may be selected ahead of data instances with lower difficulty level when sub-sampling the cluster. Different methods for sub-sampling clusters using difficulty levels and/or rareness scores associated with the scenes is described in U.S. patent application Ser. No. 18/138,645 filed Apr. 24, 2023, which has been incorporated by reference, as noted above.

In some examples, the difficulty level or rareness score may be associated with the cluster, and a higher fraction may be assigned to a cluster with a higher difficulty level during sub-sampling. For example, difficulty level of the cluster may indicate a complexity of the scenario or how hard it is for an autonomous vehicle to maneuver safely in the scenario represented by the cluster e.g., a driving scene with multiple objects close to the autonomous vehicle, or a road section with multiple turn lanes, may be assigned a higher difficulty level. In some examples, the difficulty level of the cluster may be based on an average difficulty level of data instances of the cluster. In other examples, the difficulty level of a cluster may be based on inter-cluster distances (e.g., distance between cluster means or medians) and/or cluster size. In some examples, clusters that are a greater distance from one or more respective nearest neighbors may be assigned a higher difficulty level. In some examples, smaller clusters (e.g., more than a threshold number of standard deviations from mean cluster size), which may indicate rarer scenarios, may be assigned a higher difficulty level.

Alternatively, in some examples, the process 100 may determine clusters that are more than a threshold distance from their respective nearest neighbors and/or contain less than a threshold number of data instances to be outliers (e.g., comprise noise data instances). In such examples, the clusters determined to be outliers may be removed from the clusters 124.

In some examples, the process 100 may determine a difficulty level of a data instance based on performance of a prediction component of the autonomous vehicle when provided the data instance as input. For example, if the prediction component can accurately predict future poses of objects in a scene (e.g., with low error), then the scene may be assigned a low difficulty level indicating that the autonomous vehicle systems are familiar with the scene. Whereas, if the prediction component generates larger error(s) in predicting future poses of one or more of the objects in the scene, the scene may be assigned a higher degree of difficulty.

Alternatively, or additionally, the process 100 may use a combination of constraints to generate the dataset at the operation 126. For example, different percentages of the dataset may be based on different criteria e.g., 90% may be based on uniform sub-sampling, and 10% may be based on selecting data instances with the highest difficulty level within each cluster. As another example, 60% of the dataset may be selected from clusters based on similarity of scene labels, and 40% of the dataset may be selected from clusters based on similarity in an embedding space. As yet another example, 50% of the dataset may be selected by random sampling, and 50% of the dataset may be selected based on highest distance from the centroid of respective clusters.

In some examples, the process 100 may, additionally or alternatively, receive constraints characterizing the dataset to be generated. As examples, the constraints may limit data instances included in the dataset to a specified geographical area, to those that include specified labels, to those that include specified maneuvers, and the like. In some examples, the process 100 may, additionally or alternatively, receive one or more example scenes indicating a request for a dataset of similar scenes. In such examples, the process 100 may limit the sampling to data instances that are within a threshold distance from scene descriptions corresponding to the example scene(s). As an example, the example scenes may represent scenarios that the autonomous vehicle systems are not currently handling well. In such examples, the dataset generated at the operation 126 may be used for updating models deployed by the vehicle systems to handle the scenarios.

The techniques described herein can improve a functioning of a computing device by providing a framework for determining training datasets for various machine-learned (ML) models deployed by an autonomous vehicle. By reducing the size of training datasets while maintaining diversity of training data, the training efficiency of the ML models may be improved, resulting in savings in training time and computing resources needed for training, and may generate trained ML models of reduced computational complexity. In some examples, the techniques discussed herein may reduce time and effort needed to assemble training data needed to train machine learned models for various components of the autonomous vehicle, such as object detection in sensor data, prediction of behaviors of objects in an environment the vehicle is traversing, planning a trajectory in the environment, and the like. The techniques also improve testing, debugging, and validation of components of the autonomous vehicle by providing access to relevant test data for any given scenario.

FIG. 2 illustrates an example of a scene description of a scene, such as the scene description 120, containing various objects. In examples, the objects may include an autonomous vehicle traversing an environment, and other vehicles, pedestrians, cyclists, animals etc. in the environment around the autonomous vehicle. An agent behavior 200 may include a trajectory of an object, such as an object 202, over a time period. For example, the object 202 may be located at positions 202(T, T−1, T−2, T+1, T+2, T+3, T+4) at a current time T, at previous times T−1 and T−2, and future times T+1, T+2, T+3, and T+4 respectively. Though two prior time instances and four future time instances are shown, the agent behavior 200 may include positions at more or less time instances, both during a time period prior to the current time, and during a time period after the current time. The time interval between each instance of position of the object 202 may correspond to ticks in log data generated by the autonomous vehicle or a simulation of the autonomous vehicle. For example, the time interval may be 0.1, 0.5, 1 or 2 seconds, covering a total time horizon of 5 to 10 seconds.

As shown in FIG. 2, a scene description 204 representing the agent behavior 200 may include a vector of positions of the object 202 over the time period. Each element of the vector may include an identifier 204(1), a pose 204(2), and/or map information 204(3). For example, the identifier 204(1) may indicate an object and a corresponding time instance e.g., the object 202 may be the autonomous vehicle (AV) and the time instances may be in a range (T−2, . . . . T+4) as discussed above. The pose 204(2) may include a (x, y) coordinate and a heading angle relative to a coordinate system 206, where an origin (0, 0) of the coordinate system 206 is at the position of the object 202(T) at the current time T, and the heading angle is relative to the heading angle of the object 202 at the current time T e.g., the heading angle of the object 202 is zero degrees at the time instance T. The map information 204(3) may indicate a type or category of area at the respective position e.g., the type or category may include a driving lane, crosswalk, road junction, turn lane, parking lane, and the like.

The scene description 204 may include object behaviors for one or more objects of interest in the scene, as indicated by ellipsis 204(4). Each object behavior may be described as a vector of positions over time relative to a coordinate system anchored on the respective object's pose at time instance T, as described with reference to the object 202. In some examples, the scene description 204 may comprise a concatenation of individual object behaviors.

Additionally, in some examples, the scene description 120 may include a representation similar to the scene description 204 to capture one or more agent interaction(s) 208 between objects e.g., capturing relative positions of an object with respect to the autonomous vehicle during an interaction between the object and the autonomous vehicle. Such interactions may include driving scenarios where the object is proximate to the autonomous vehicle, actions of the object impact actions taken the autonomous vehicle for safe operation, and/or trajectories of the object and the autonomous vehicle intersect during the period of time.

In the example agent interaction 208 illustrated in FIG. 2, an object 210 is taking a left turn across a path of an autonomous vehicle (AV) 212. Positions of the object 210 at time instances (T−2, . . . , T+4) are shown at 210(T−2, . . . , T+4) respectively. Similarly, positions of the autonomous vehicle 212 at the same time instances (T−2, . . . , T+4) are shown at 212(T−2, . . . , T+4) respectively. In such an example, a scene description 214 capturing the agent interaction 208 may include feature vectors 214(1) corresponding to the autonomous vehicle 212 and feature vectors 214(2) corresponding to the object 210 at corresponding time instances. The positions of the object 210 and the autonomous vehicle 212 in the scene description 214 are relative to a coordinate system 216, where an origin (0, 0) of the coordinate system 216 is located at the position 212(T) of the autonomous vehicle 212 at the current time instance T. As described with reference to the scene description 204, heading angles of the object 210 and the autonomous vehicle 212 at times (T−2, . . . , T+4) may be specified relative to a heading angle of the autonomous vehicle 212 at the time instance T e.g., with the heading angle at position 212(T) considered to be at zero degrees.

In examples, the process 100 may perform a pruning step to exclude one or more objects in the scene so that the scene description 214 may not include interactions between every pair comprising an object in the scene and the autonomous vehicle. For example, stationary objects, objects at a distance from the autonomous vehicle that is greater than a threshold distance, specific categories or types of objects, and the like may be excluded to reduce a size of the scene description 214. As discussed, the size of the scene description 214 may also be reduced by applying a dimensionality reduction technique to an initial scene description based on interactions between the objects in the scene.

FIG. 3 illustrates another example of a scene description of a scene, such as the scene description 120, containing various objects. As an example, FIG. 3 illustrates a driving scenario 300 including an autonomous vehicle 302, and other objects such as cars 304(1) and 304(2) and cyclist 304(3) in a vicinity of the autonomous vehicle 302. As shown, each object in the scene is associated with a trajectory along which the object is moving or driving, such as trajectory 306 of the autonomous vehicle 302. In examples, objects in the scene may also be associated with a set of labels 308 or tags, as described in U.S. patent application Ser. No. 18/138,645 filed Apr. 24, 2023, which is incorporated by reference, as noted above. For example, a scene may be associated with labels or tags indicating maneuvers, types of vehicles, spatial relationships, type of location, and the like. In the example shown in FIG. 3, the labels 308 include a relative location to the autonomous vehicle 302 in a direction in front of and lateral to the autonomous vehicle 302 (e.g., “close right,” “close front,” “close left,” etc.), a direction of approach (e.g., “left,” “right,” “along,” oncoming,” etc.), a velocity level (e.g., “medium velocity,” “high velocity,” “slow,” “stationary,” etc.), and a type of object (e.g., “car,” “cyclist,” “truck,” “pedestrian,” “AV,” etc.). However, other labels representing features such as a type of map feature (e.g., driving lane, turn lane, crosswalk, parking lane, etc.), speed limits, construction status, and the like, may also be applied to describe the location where an object is present.

In examples, an area proximate the autonomous vehicle 302 may be spatially binned into bins 310. As shown in FIG. 3, the bins 310 may be shaped by the trajectory 306 of the autonomous vehicle 302, where the axes of the bins 310 are along the trajectory 306 (e.g., indicating distance along the trajectory 306) and perpendicular to the trajectory 306 (e.g., indicating lateral distance from the trajectory 306) at each point in the trajectory 306. The spatial extent of the bins 310 may be selected based on a speed of the autonomous vehicle 302, relative orientation to a heading (or yaw) of the autonomous vehicle 302, a number, density, and/or type of objects in the scene, complexity of roadways in the scene, and the like. In some examples, the spatial extents and/or shapes of the bins 310 may be configurable automatically based on input parameters, the number of bins 310 may be based on data available e.g., the trajectory 306 may only be available for 80 meters or 200 meters.

In some examples, each bin, such as a bin 310(n) shown, may be described by a feature vector, such as feature vector 312(n) corresponding to the bin 310(n). The feature vector 312(n) may comprise cells 314 corresponding to each possible label that may be applied to the scene (such as the example labels 308). The feature vector 312(n) may describe content of the corresponding bin 310(n) by indicating a presence (or absence) of each label in the bin 310(n) e.g., if a label corresponding to a cell (e.g., cell 314(1)) is present in the bin 310(n), the cell value may be set to 1 (as indicated by the dark shading of the cell 314(1)), whereas if a label corresponding to cell (e.g., cell 314(2)) is not present in the bin 310(n), the cell value may be set to 0 (as indicated by the unshaded cell 314(2)). In some examples, each cell of the cells 314 may indicate a count of the number of times the corresponding label was present in the bin 310(n) after aggregating labels from all objects within the bin. In some examples, the counts may be grouped into ranges of values (e.g., 1-5, 5-25, 25+). In some examples, exclusive labels may be grouped together (e.g., when only one label of the group may be present), and each group may correspond to a one-hot vector indicating the label of the group that is present. In additional or alternate examples, the feature vectors 312 may comprise a set of one-hot vectors representing elements in a cross product of possible labels over the bins 310.

In examples, a scene description 312 of the scene as discussed above may comprise a set of the feature vectors 312(1, . . . , M) corresponding to the bins 310(1, . . . , M) in the scene.

In some examples, bins that are not relevant to the scene description may be omitted e.g., bins that are more than a first threshold distance behind the autonomous vehicle 302 based on the known trajectory 306 of the vehicle 302, bins that are more than a second threshold distance from the vehicle 302 in an opposite side of the roadway, bins that are on sidewalks or other non-drivable surfaces of the scene, and the like.

As discussed with reference to the scene description 120 of FIG. 1, a functional description of a scene and objects in the scene are captured in internal representations of the scene generated by ML models trained for prediction tasks e.g., predicting behaviors of the objects or trajectories of the objects in the scene. FIG. 4 illustrates block diagrams of alternative ML models 400, 402 trained for prediction tasks given an input scene, illustrating embeddings that may be used as a scene description, such as the scene description 120. In some examples, the scene description 120 may comprise such embeddings generated by trained ML models instead of, or in addition to, the scene descriptions 204, 214, 312 described with reference to FIGS. 2 and 3. In some examples, the ML models 400, 402 may be large-scale, offline models trained on very large training datasets of input scenes (e.g., millions of scenes), similar to the scenes 104. Such large-scale, offline models may be separate from ML models deployed by the autonomous vehicle systems on-board the autonomous vehicle e.g., the deployed ML models may be streamlined or smaller models based on limitations of computing resources on-board the vehicle. In other examples, the ML models 400, 402 may correspond to models deployed by the autonomous vehicle systems.

As shown, the ML model 400 is a transformer-based ML model for prediction. In examples, the ML model 400 may accept, as input, a scene 404, which may be a top-down representation similar to the scenes 104 shown in FIG. 1, and output a prediction 406 e.g., a future behavior or pose of object(s) in the input scene 404. Though a top-down representation is used as an example, the scene 404 may be input in other formats or from other viewpoints matching the scenes 104. An example transformer-based ML model that receives a top-down representation as input and outputs predicted state(s) of objects is described in U.S. patent application Ser. No. 18/227,813 filed Jul. 28, 2023, which has been incorporated by reference, as noted above.

In examples, the scene 404 may be provided to an encoder 408 of the transformer to obtain one or more embedding(s) 410(1, . . . , N). In some examples, the embedding(s) 410 May correspond to projections of top-down patches of the top-down representation, along with respective position encodings, into an embedding space. The embedding(s) 410 may be a high-dimensional vector or tensor that represents the input scene in the embedding space. Though one encoder and one set of embeddings is shown for simplicity, the transformer may accept multiple inputs related to the scene 404 (e.g., map data, sensor data, and the like), each type of input being processed by a different encoder component, and generating a different set of embedding(s) e.g., as described in U.S. patent application Ser. No. 18/304,975 filed Apr. 21, 2023, which is herein incorporated by reference, as noted above. For example, U.S. patent application Ser. No. 18/304,975 describes a transformer-based model that generates embeddings of image data and map data in respective embedding spaces.

In examples, the encoder 408 may be trained to determine the embedding(s) 410 during a process of training the transformer-based ML model 400, which may include training of other transformer operations 412 such as attention mechanism, decoders, etc. for prediction of future poses of the objects in the scene, as described in U.S. patent application Ser. No. 18/227,813 filed Jul. 28, 2023, and incorporated by reference, as noted above.

In some examples of the present disclosure, a scene, such as the scene 104(n), may be provided as an input to the trained transformer-based ML model 400, and the embedding(s) 410 determined by the encoder 408 may be used as the scene description 120. In examples where the scene 104(n) is represented by different sets of embeddings, the scene description 120 may comprise a combination (e.g., a concatenation, an average, an embedding determined by a multi-layer perceptron that determines the embedding using the input embeddings) of the embeddings generated by the separate encoders.

Additionally, the prediction 406 generated by the transformer-based ML model 400 given the input scene, such as the scene 104(n), may be compared with actual pose data of objects at the predicted time instances, which are available in the scenes 104, to determine prediction error(s) 414. In some examples, the prediction error(s) 414 may be determined based at least in part on determining a difference between a prediction of a future object state generated at a first time to a detected object state at that future time once it has come to pass. As discussed with reference to FIG. 1, the prediction error(s) 414 may be used to represent a difficulty level of the input scene 104(n) e.g., higher prediction error(s) 414 indicating a higher difficulty level of the scene 104(n).

As another example, the ML model 402, based on a graph neural network (GNN) architecture may alternatively, or additionally, be used to determine embeddings representing the scene 104(n) of the scenes 104. In the example shown, the ML model 402 may accept, as inputs, agent histories 418(1, . . . , M) (such as the agent descriptors 116 or the agent behaviors 200) indicating positions of objects in the scene over a time period, and generate, as output, a prediction 416 e.g., future positions/poses of the objects. For example, the agent histories 418(1, . . . , M) may correspond to the agent descriptors 116. An encoder component 420 may generate an embedding of the agent histories 418(1, . . . , M) in an embedding space, to determine agent embeddings 422(1, . . . , M) corresponding to node embeddings of the GNN. In examples, the encoder component 420 may be implemented as a multi-layer perceptron (MLP) neural network that learns a mapping from nodes in input graph(s) to node embeddings that are low-dimensional vectors capturing the characteristics of the graph(s). The encoder component 420 is trained during a process of training the ML model 402 for the prediction task e.g., generating the prediction 416.

In some examples, an output of the encoder component 420 may be combined with a scene context 424 to determine the agent embeddings 422. In examples, the scene context 424 may be an output of an encoder generating a scene embedding based on map data, top-down view of scene, scene segmentation, and the like, similar to the encoders described in U.S. patent application Ser. No. 18/227,813 and U.S. patent application Ser. No. 18/304,975 referenced above. In some examples, the scene description 120 may comprise the agent embedding(s) 422, as well as interaction embedding 426 capturing interactions between the objects obtained from the trained GNN-based ML model 402.

As described with reference to the ML model 400, a prediction error(s) 428 may also be determined by comparing the prediction 416 with known poses and positions of the objects. In some examples, the prediction error(s) 428 may determine the difficulty level of the input, as discussed with reference to FIG. 1.

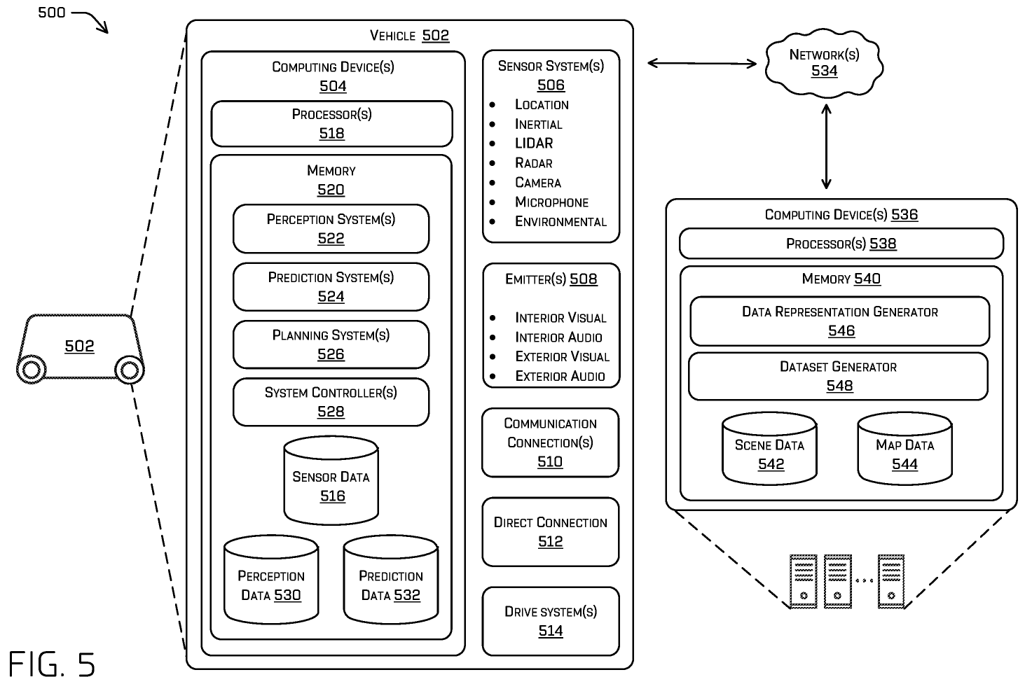

FIG. 5 depicts a block diagram of an example system 500 for implementing the techniques discussed herein. In at least one example, the system 500 may include a vehicle 502, such as the autonomous vehicles discussed above. The vehicle 502 may include computing device(s) 504, one or more sensor system(s) 506, one or more emitter(s) 508, one or more communication connection(s) 510 (also referred to as communication device(s) and/or modems), at least one direct connection 512 (e.g., for physically coupling with the vehicle 502 to exchange data and/or to provide power), and one or more drive system(s) 514. The one or more sensor system(s) 506 may be configured to capture the sensor data 516 associated with a surrounding physical environment.

In at least some examples, the sensor system(s) 506 may include time-of-flight sensors, location sensors (e.g., GPS, compass, etc.), inertial sensors (e.g., inertial measurement units (IMUs), accelerometers, magnetometers, gyroscopes, etc.), lidar sensors, radar sensors, sonar sensors, infrared sensors, cameras (e.g., RGB, IR, intensity, depth, etc.), microphone sensors, environmental sensors (e.g., temperature sensors, humidity sensors, light sensors, pressure sensors, etc.), ultrasonic transducers, wheel encoders, etc. In some examples, the sensor system(s) 506 may include multiple instances of each type of sensor. For instance, time-of-flight sensors may include individual time-of-flight sensors located at the corners, front, back, sides, and/or top of the vehicle 502. As another example, camera sensors may include multiple cameras disposed of at various locations about the exterior and/or interior of the vehicle 502. In some cases, the sensor system(s) 506 may provide input to the computing device(s) 504.

The vehicle 502 may also include one or more emitter(s) 508 for emitting light and/or sound. The one or more emitter(s) 508 in this example include interior audio and visual emitters to communicate with passengers of the vehicle 502. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The one or more emitter(s) 508 in this example also include exterior emitters. By way of example and not limitation, the exterior emitters in this example include lights to signal a direction of travel or other indicators of vehicle action (e.g., indicator lights, signs, light arrays, etc.), and one or more audio emitters (e.g., speakers, speaker arrays, horns, etc.) to audibly communicate with pedestrians or other nearby vehicles, one or more of which may comprise acoustic beam steering technology.

The vehicle 502 can also include one or more communication connection(s) 510 that enable communication between the vehicle 502 and one or more other local or remote computing device(s) (e.g., a remote teleoperations computing device) or remote services. For instance, the communication connection(s) 510 can facilitate communication with other local computing device(s) on the vehicle 502 and/or the drive system(s) 514. Also, the communication connection(s) 510 may allow the vehicle 502 to communicate with other nearby computing device(s) (e.g., other nearby vehicles, traffic signals, etc.).

The communications connection(s) 510 may include physical and/or logical interfaces for connecting the computing device(s) 504 to another computing device or one or more external network(s) 534 (e.g., the Internet). For example, the communications connection(s) 510 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s). In at least some examples, the communication connection(s) 510 may comprise the one or more modems as described in detail above.

In at least one example, the vehicle 502 may include one or more drive system(s) 514. In some examples, the vehicle 502 may have a single drive system 514. In at least one example, if the vehicle 502 has multiple drive systems 514, individual drive systems 514 may be positioned on opposite ends of the vehicle 502 (e.g., the front and the rear, etc.). In at least one example, the drive system(s) 514 can include one or more sensor system(s) 506 to detect conditions of the drive system(s) 514 and/or the surroundings of the vehicle 502. By way of example and not limitation, the sensor system(s) 506 can include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders may be unique to the drive system(s) 514. In some cases, the sensor system(s) 506 on the drive system(s) 514 can overlap or supplement corresponding systems of the vehicle 502 (e.g., sensor system(s) 506).

The drive system(s) 514 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate the loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 514 can include a drive system controller which may receive and preprocess data from the sensor system(s) 506 and to control operation of the various vehicle systems. In some examples, the drive system controller can include one or more processor(s) and memory communicatively coupled with the one or more processor(s). The memory can store one or more modules to perform various functionalities of the drive system(s) 514. Furthermore, the drive system(s) 514 also includes one or more communication connection(s) that enable communication by the respective drive system with one or more other local or remote computing device(s).

The computing device(s) 504 may include one or more processors 518 and one or more memories 520 communicatively coupled with the processor(s) 518. In the illustrated example, the memory 520 of the computing device(s) 504 stores perception systems(s) 522, prediction systems(s) 524, planning systems(s) 526, as well as one or more system controller(s) 528. The memory 520 may also store data such as sensor data 516 captured or collected by the one or more sensors systems 506, perception data 530 associated with the processed (e.g., classified and segmented) sensor data 516, prediction data 532 associated with one or more predicted state of the environment and/or detected objects within the environment. Though depicted as residing in the memory 520 for illustrative purposes, it is contemplated that the perception systems(s) 522, prediction systems(s) 524, planning systems(s) 526, as well as one or more system controller(s) 528, may additionally, or alternatively, be accessible to the computing device(s) 504 (e.g., stored in a different component of vehicle 502 and/or be accessible to the vehicle 502 (e.g., stored remotely).

The perception system 522 may be configured to perform object detection, segmentation, and/or classification on the sensor data 516. In some examples, the perception system 522 may generate processed perception data 530 from the sensor data 516. The perception data 530 may indicate a presence of objects that are in physical proximity to the vehicle 502 and/or a classification or type of the objects (e.g., car, pedestrian, cyclist, building, tree, road surface, curb, sidewalk, unknown, etc.). In additional and/or alternative examples, the perception system 522 may generate or identify one or more characteristics associated with the objects and/or the physical environment. In some examples, characteristics associated with the objects may include, but are not limited to, an x-position, a y-position, a z-position, an orientation, a type (e.g., a classification), a velocity, a size, a direction of travel, etc. Characteristics associated with the environment may include, but are not limited to, a presence of another object, a time of day, a weather condition, a geographical area position, an indication of darkness/light, etc. For example, details of classification and/or segmentation associated with a perception system are discussed in U.S. application Ser. No. 15/820,245, which are herein incorporated by reference in their entirety for all purposes.

The prediction system 524 may be configured to determine a track corresponding to an object identified by the perception system 522. For example, the prediction system 524 may be configured to predict a velocity, position, change in trajectory, or otherwise predict the decisions and movement of the identified objects. For example, the prediction system 524 may include one or more machine learned models that may, based on inputs such as object type or classification and object characteristics, output predicted characteristics of the object at one or more future points in time. For example, details of prediction systems are discussed in U.S. application Ser. Nos. 16/246,208 and 16/420,050, which are herein incorporated by reference in their entirety.

The planning system 526 may be configured to determine a route for the vehicle 502 to follow to traverse through an environment. For example, the planning system 526 may determine various routes and paths and various levels of detail based at least in part on the objects detected, the predicted characteristics of the object at future times, and a set of safety specifications corresponding to the current driving sequence (e.g., combination of objects detected and/or environmental conditions). In some instances, the planning system 526 may determine a route to travel from a first location (e.g., a current location) to a second location (e.g., a target location) in order to avoid an object obstructing or blocking a planned path of the vehicle 502. In some cases, a route can be a sequence of waypoints for traveling between the two locations (e.g., the first location and the second location). In some cases, waypoints include streets, intersections, global positioning system (GPS) coordinates, etc. For example, details of path and route planning by the planning system are discussed in U.S. application Ser. Nos. 16/805,118 and 15/732,208, which are herein incorporated by reference, in their entirety.

In at least one example, the computing device(s) 504 may store one or more and/or system controllers 528, which may be configured to control steering, propulsion, braking, safety, emitters, communication, and other systems of the vehicle 502. The system controllers 528 may communicate with and/or control corresponding systems of the drive system(s) 514 and/or other components of the vehicle 502, which may be configured to operate in accordance with a route provided by the planning system 526.

In some implementations, the vehicle 502 may connect to computing device(s) 536 via the network(s) 534. The computing device(s) 536 may include one or more processors 538 and memory 540 communicatively coupled with the one or more processors 538. In at least one instance, the processor(s) 538 may be similar to the processor(s) 518 and the memory 540 may be similar to the memory 520. In the illustrated example, the memory 540 of the computing device(s) 536 stores scene data 542 which may be received from the vehicle 502, or determined based on data (e.g., the sensor data 516, the perception data 530, etc.) received from the vehicle 502 or one or more vehicles similar to the vehicle 502. The memory 540 may also store map data 544 associated with objects and/or the vehicle 502 represented in the scene data 542.

In examples, the computing device(s) 536 may receive the scene data 542 from one or more vehicles 502. The scene data 542 may include the sensor data 516, perception data 530, prediction data 532, and/or a combination thereof. In some cases, the scene data 542 may include a sequence of one or more of the sensor data, perception data 530, and prediction data 532 e.g., over a period of time. In some examples, a top-down representation of scenes traversed by the vehicle 502 may be generated from the sensor data 516, in conjunction with the map data 544 of the environment. For example, techniques for determining a top-down representation of the environment based at least in part on the sensor data, are discussed in U.S. Patent Application Pub. No. 2021/0181758, filed Jan. 30, 2020, and/or U.S. Pat. No. 10,649,459, issued on Apr. 26, 2018, the entirety of which are incorporated by reference, as noted above.

The memory 540 may also store a data representation generator 546 and a dataset generator 548. The data representation generator 546 and the dataset generator 548 may implement operations 114, 122, and 126 of the process 100 described with respect to FIG. 1.

The data representation generator 546 may generate scene descriptions such as the scene description 120, for each scene in the scene data 542. As an example scene description described with reference to FIG. 2, the scene description may comprise feature vectors indicating a sequence of poses of objects in the scene, relative to a pose of the respective object at an initial time, T. The scene description may also include feature vectors representing interactions between the vehicle 502 and one or more objects in the scene, where the poses of the vehicle 502 and the one or more objects are with respect to a reference frame anchored at a pose of the vehicle 502 at the initial time, T. In some examples, the feature vectors may include map information e.g., indicating a classification of a location corresponding to each pose.

As another example scene description, as described with reference to FIG. 3, the scene description may be based on aggregating, within spatial bins, of scene labels applied to portions of the scene. The data representation generator 546 may determine the spatial bins relative to a trajectory of the vehicle 502. The scene description may comprise a vector indicating labels that are present within each spatial bin. In yet another example scene description, as described with reference to FIG. 4, the data representation generator 546 may input scene data corresponding to the scene to an encoder component of a trained ML-based prediction model, and receive an input embedding corresponding to the scene. Such an embedding may be used as a scene description. The data representation generator 546 may also determine the scene descriptions based on a combination of the scene description examples described above.

The dataset generator 548 may cluster the scene representations determined by the data representation generator 546 by similarity. In a non-limiting example, the dataset generator 548 may apply k-means clustering on the scene representations to determine a plurality of scene clusters, each representing scenes with similar scene representations. The dataset generator 548 may receive an instruction to generate a dataset, indicating criteria of a target dataset. Such criteria may include a size of the target dataset, a type or types of scene description to be used to measure similarity, constraint(s) on geographic area or labels present, and the like. The dataset generator 548 may sample the plurality of clusters to generate a dataset matching the criteria of the target dataset. In some examples, the dataset generator 548 may sample clusters in decreasing order of difficulty level of the scenes in the cluster, where the difficulty level is indicative of a complexity of the scene or based on a prediction error when the scene is input to a trained, ML-based prediction model.

The processor(s) 518 of the computing device(s) 504 and the processor(s) 538 of the computing device(s) 536 may be any suitable processor capable of executing instructions to process data and perform operations as described herein. By way of example and not limitation, the processor(s) 518 and 538 can comprise one or more Central Processing Units (CPUs), Graphics Processing Units (GPUs), or any other device or sequence of a device that processes electronic data to transform that electronic data into other electronic data that can be stored in registers and/or memory. In some examples, integrated circuits (e.g., ASICs, etc.), gate arrays (e.g., FPGAs, etc.), and other hardware device(s) can also be considered processors in so far as they are configured to implement encoded instructions.

The memory 520 of the computing device(s) 504 and the memory 540 of the computing device(s) 536 are examples of non-transitory computer-readable media. The memory 520 and 540 can store an operating system and one or more software applications, instructions, programs, and/or data to implement the methods described herein and the functions attributed to the various systems. In various implementations, the memory 520 and 540 can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

In some instances, aspects of some or all of the components discussed herein can include any models, algorithms, and/or machine learning algorithms. For example, in some instances, the components in the memory 520 and 540, such as the perception system(s) 522, prediction system(s) 524, planning system(s) 526, data representation generator 546, dataset generator 548, and/or the machine-learned model trained according to the techniques discussed herein can include machine-learned model(s) implemented as a neural network. Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, Xception, ConvNext, and the like; visual transformer(s) (ViT(s)), such as a bidirectional encoder from image transformers (BEIT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/973,833, which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

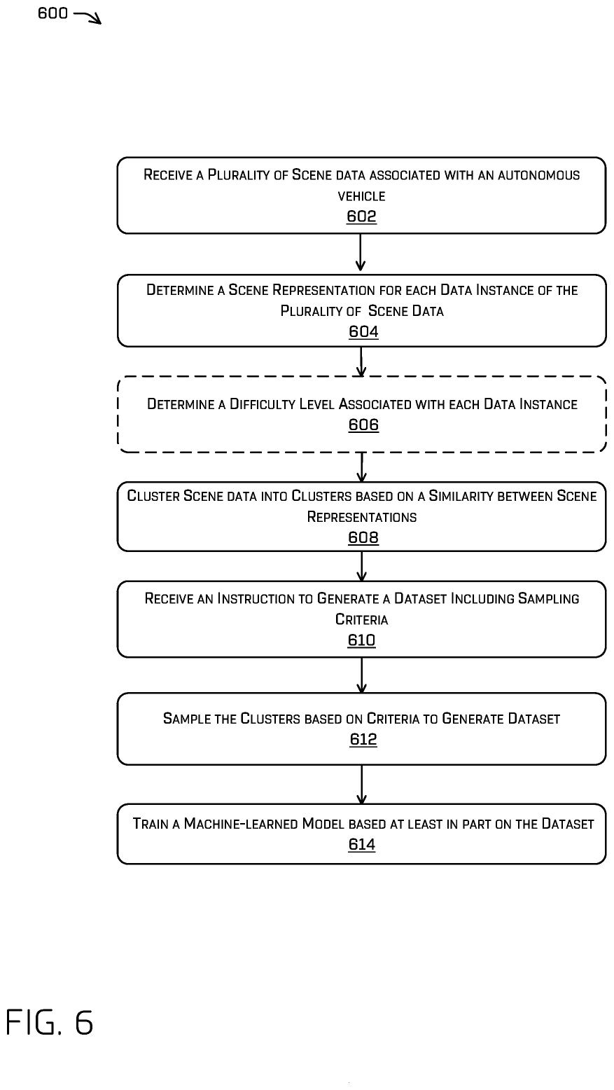

FIG. 6 illustrates a flow diagram of an example process 600 for generating a training dataset with clustered scenarios. In the example process 600, the order in which the operations are described should not be construed as a limitation. Any number of the described blocks can be combined in any order and/or in parallel to implement the processes, or alternative processes, and not all of the blocks need to be executed. For discussion purposes, the processes herein are described with reference to the frameworks, architectures, and environments described in the examples herein, although the process may be implemented in a wide variety of other frameworks, architectures, or environments.

At operation 602, the process 600 may include receiving a plurality of scene data associated with an autonomous vehicle. In some instances, the autonomous vehicle may be an autonomous vehicle configured to operate according to a Level 5 classification issued by the U.S. National Highway Traffic Safety Administration or a simulated autonomous vehicle in a virtual environment. In some examples, the plurality of scene data may correspond to the scenes 104 and comprise top-down representations of a driving scenario. In some examples, the plurality of scene data may include map data and location data corresponding to an environment being traversed by the autonomous vehicle. The plurality of scene data may also include time data that associates the actions and/or poses of the autonomous vehicle and objects in the scene with a set of timestamps. In other examples, additionally, or alternatively, the plurality of scenes may include log data comprising sensor data, perception data, prediction data, planning data, vehicle status data, velocity data, intent data, and/or other data generated by the autonomous vehicle while traversing the environment.

At operation 604, the process 600 may include determining a scene representation for each data instance of the plurality of scene data. Examples of the scene representation, such as the scene description 120, may include the example scene representation described with reference to FIG. 2, the example scene representation described with reference to FIG. 3, the example scene representation described with reference to FIG. 4, or a combination of the scene representations. As described, the scene representation may capture aggregate information about the data instance such as trajectories of various objects in the scene. For example, the scene representation may utilize feature vectors representing trajectories of the objects and interactions between objects and the autonomous vehicle, labels aggregated in spatial bins, and/or embeddings obtained from trained ML prediction models, as described above.

At operation 606, the process 600 may include determining a difficulty level associated with each data instance. In some examples, the difficulty level may indicate a level of familiarity of vehicle prediction models(s) with scenarios similar to the data instance e.g., based on an accuracy of prediction achieved when the data instance is provided as input to the prediction model(s). For example, larger errors may correspond to a higher difficulty level. In another example, the difficulty level may indicate how hard it is for an autonomous vehicle to maneuver safely in the scenario represented by the data instance e.g., a driving scene with multiple objects close to the autonomous vehicle, or a road section with multiple turn lanes, may be assigned a higher difficulty level. The process 600 may also use a combination of the above to determine a difficulty level. In some examples, the process 600 may not perform the operation 606, and a difficulty level may not be available for the data instances of the plurality of scene data.

At operation 608, the process 600 includes clustering the plurality of scene data into clusters based on a similarity between scene representations of the data instances. For example, a distance metric (e.g., cosine distance, Manhattan distance, Minkowski distance, Euclidean distance, etc.) between the scene descriptions may be defined such that a shorter distance between scene descriptions indicate higher similarity. In some examples, the distance metric used for clustering may be based on an output of a machine-learned (ML) model trained on scene feature vectors corresponding to similar and non-similar scenes. As a non-limiting example, k-means clustering may be used to determine scene clusters based on similarity of scene descriptions. However, various other clustering techniques may also be used e.g., k-medians, agglomerative, expectation maximization (EM), hierarchical clustering, density-based clustering, etc.

At operation 610, the process 600 includes receiving an instruction to generate a dataset, the instruction including sampling criteria for sampling the clusters determined at the operation 608. For example, the sampling criteria may indicate a target size of the dataset (e.g., a maximum storage amount in gigabytes and/or a total number of data instances). As another example, the sampling criteria may limit data instances to a specified geographical area. The sampling criteria may also limit data instances to those that include specified labels as described with reference to FIG. 3. In some examples, the sampling criteria may provide a combination of constraints. In some examples, the instructions may include, additionally or alternatively, one or more example scenes (e.g., query scene(s)) indicating a request for a dataset of similar scenes.

At an operation 612, the process 600 includes sampling the scene clusters based on the sampling criteria to generate a dataset. In examples, the process 600 may determine a sub-sampling fraction e.g., by dividing the target dataset size by the total size of data instances in the scene clusters. In some examples, the scene clusters may be sampled based on the sub-sampling fraction, selecting data instances in decreasing order of difficulty level. In some examples, the scene clusters may be sampled by selecting data instances in decreasing order of distance from a centroid of the respective scene cluster e.g., selecting data instances that are less common within the scene cluster. The process 600 may also limit the selection of data instances to data instances satisfying constraints of the sampling criteria e.g., specifying geographic locations and/or labels. In examples where query scene(s) are provided, the process 600 may limit data instances included in the dataset to those data instances that are within a threshold distance from the query scene(s).

In some examples, at the operation 612, the process 600 may generate a training dataset and a test dataset, ensuring that there are no data instances common between the training dataset and the test dataset. For example, the process 600 may remove from consideration the data instances included in the training dataset before sampling remaining data instances to generate the test dataset.

At an operation 614, the process 600 may include training a ML model based at least in part on the dataset. For example, the dataset can be used for training, testing, and/or validating a component of an autonomous vehicle based on a ML model, such as the perception component, the prediction component, or the like. Additionally, the dataset can be used by a simulation system deploying ML models in simulations of the driving environment. In examples where a training dataset and a test dataset are generated, the ML model may be trained based on the training dataset and performance characteristics (e.g., accuracy) of the trained ML model may be obtained by using the test dataset as input.

### EXAMPLE CLAUSES

A: A system comprising: one or more processors; and one or more computer-readable media storing processor-executable instructions that, when executed by the one or more processors, cause the system to perform operations comprising: receiving first scene data corresponding to a first scene, the first scene data including an environment representation, a first pose of an autonomous vehicle at a first time, and an indication of an object; determining, based at least in part on the first pose, a second pose of the object at the first time, relative to the first pose; determining, based at least in part on the first pose and the second pose, a representation of the first scene; determining a difficulty level associated with the first scene data based at least in part on an error of prediction, by a machine-learned model, of a third pose of the object at a second time different from the first time; associating the first scene data with a first cluster from among a set of clusters, the first cluster indicating a set of scene data; generating a dataset based at least in part on sampling scene data from the set of clusters, wherein the dataset includes the first scene and at least a subset of the set of scene data indicated by the first cluster, wherein generating the dataset comprises selecting, based on the difficulty level being greater than a threshold, at least the first scene to be included in the dataset; and training a machine-learned model based at least in part on the dataset.

B: The system of paragraph A, wherein the first scene data further includes a fourth pose of the autonomous vehicle, relative to the first pose, at a third time before the first time, and the operations further comprising: determining, based at least in part on the first pose, a fifth pose of the object at the third time, relative to the first pose.

C: The system of paragraph A or B, wherein the representation of the first scene comprises: a first feature vector identifying the first pose as an origin of a reference frame, a second feature vector identifying a position and orientation corresponding to the second pose based on the reference frame.

D: The system of paragraphs A-C, wherein the first pose is associated with a geographic location and the first feature vector further identifies a classification associated with the geographic location, the classification comprising one of: driving lane, turning lane, road junction, parking spot, traffic light intersection, or shoulder lane.

E: The system of any one of paragraphs A-D, wherein the first scene data is associated with the first cluster based at least in part on determining a similarity between the representation and an attribute associated with the first cluster, the attribute being a representation of mean scene data of the first cluster.

F: A method comprising: receiving a plurality of scene data, each indicating an environment traversed by an autonomous vehicle; determining a plurality of feature vectors, each representing a scene data of the plurality of scene data; clustering, based on a distance metric in a space of the feature vectors, the plurality of feature vectors into one or more clusters, each cluster representing a subset of the plurality of scene data; and generating, by sub-sampling the one or more clusters, the dataset of the target size, wherein the sub-sampling selects at least one scene data from the one or more clusters.

G: The method of paragraph F, wherein determining the plurality of feature vectors comprises: inputting respective scene data to a trained, machine-learned (ML) model configured to output a prediction related to the respective scene data; receiving, from the ML model, an embedding representing the respective scene data, wherein a feature vector corresponding to the respective scene data comprises the embedding.

H: The method of paragraph F or G, wherein: the ML model is a transformer-based ML model and the embedding is generated by an encoder component, or the ML model is a graph neural network (GNN) and the embedding corresponds to a node embedding of the GNN.

I: The method of any one of paragraphs F-H, wherein determining a feature vector corresponding to a respective scene data comprises: determining, based on the respective scene data, a trajectory of the autonomous vehicle; determining, based on the trajectory, a plurality of spatial bins within an area of the environment covered by the respective scene data, wherein the feature vector comprises an aggregation of scene labels of the respective scene data within each spatial bin of the plurality of spatial bins.

J: The method of any one of paragraphs F-I, wherein determining a feature vector corresponding to a respective scene data comprises: determining, based on the respective scene data, a first feature vector including scene labels associated with the respective scene data; and determining, based on the respective scene data, a second feature vector, different from the first feature vector, the second feature vector being represented in a high-dimensional vector space, wherein the feature vector comprises a combination of the first feature vector and the second feature vector.

K: The method of any one of paragraphs F-J, wherein determining a feature vector corresponding to a respective scene data comprises: determining, based on a reference pose of the autonomous vehicle at a first time, a reference frame for the respective scene data; determining, based on the reference frame, a first pose corresponding to an object represented in the scene data at the first time; determining, based on the reference frame, a second pose corresponding to the object at a second time, before the first time; determining, based on the reference frame, a third pose corresponding to the object at a third time, after the first time, wherein the feature vector comprises an indication of at least the reference pose, the first pose, the second pose, and the third pose.

L: The method of any one of paragraphs F-K, wherein determining a feature vector corresponding to a respective scene data comprises: determining, for a first object represented in the scene data and based on a reference pose of the first object at a reference time instant, a first reference frame for the first object; determining, based on the first reference frame, first poses of the first object at first time instances different from the reference time instant; determining, for a second object represented in the scene data and based on a reference pose of the second object at the reference time instant, a second reference frame for the second object; determining, based on the second reference frame, second poses of the second object at the first time instances, wherein the feature vector comprises an indication of at least the first poses and the second poses.

M: The method of any one of paragraphs F-L, wherein the sub-sampling selects the scene data from the cluster based on a difficulty level of the scene data.

N: The method of any one of paragraphs F-M, wherein determining the difficulty level of the scene data comprises: receiving, as output from a machine-learned prediction model, a predicted pose of an object represented in the scene data; determining, based on the scene data, an error between the predicted pose and an actual pose of the object, wherein the difficulty level is based at least in part on the error.

O: The method of any one of paragraphs F-N, wherein the difficulty level is based on a complexity of scene, the complexity indicative of one or more of: a number of objects in the scene data, a density of objects in the scene data, a distance between the autonomous vehicle and an object in the scene, a map feature in the scene data, or a speed of the autonomous vehicle or an object in the scene.

P: One or more non-transitory computer-readable media storing processor-executable instructions that, when executed by one or more processors, perform operations comprising: receiving scene data comprising a plurality of top-down representations of an environment; determining a plurality of scene features representing the scene data; clustering, based on a similarity between the scene features, the scene data into one or more clusters, each cluster representing a subset of the plurality of top-down representations; receiving an instruction to generate a dataset, the instruction indicating criteria of a target dataset; sampling, based on the criteria of the target dataset, the one or more clusters; and generating the dataset satisfying the criteria, the dataset comprising a subset of the scene data.

Q: The one or more non-transitory computer-readable media of paragraph P, each top-down representation associated with a respective time instant, and the scene features include a representation of objects in the environment over a period of time.

R: The one or more non-transitory computer-readable media of paragraph P or Q, wherein the scene features comprise an embedding of respective top-down representations generated by a trained machine-learned model configured to output predicted states based on an input top-down representation.

S: The one or more non-transitory computer-readable media of any one of paragraphs P-R, wherein the sampling: comprises selecting a subset of top-down representations from each cluster of the one or more clusters, and is based on a difficulty level of respective top-down representations.

T: The one or more non-transitory computer-readable media of any one of paragraphs P or S, wherein the difficulty level of a top-down representation is based on a prediction error generated by a trained ML model when provided, as input, the top-down representation.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially the same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system, comprising:
one or more processors; and
non-transitory memory storing processor-executable instructions that, when executed by the one or more processors, cause the system to perform operations comprising:
receiving first scene data corresponding to a first scene, the first scene data including an environment representation, a first pose of an autonomous vehicle at a first time, and an indication of an object;
determining, based at least in part on the first pose, a second pose of the object at the first time, relative to the first pose;
determining, based at least in part on the first pose and the second pose, a representation of the first scene;
determining a difficulty level associated with the first scene data based at least in part on an error of prediction, by a machine-learned model, of a third pose of the object at a second time different from the first time;
associating the first scene data with a first cluster from among a set of clusters, the first cluster indicating a set of scene data;
generating a dataset based at least in part on sampling scene data from the set of clusters, wherein the dataset includes the first scene and at least a subset of the set of scene data indicated by the first cluster,
wherein generating the dataset comprises selecting, based on the difficulty level being greater than a threshold, at least the first scene to be included in the dataset; and
training a machine-learned model based at least in part on the dataset.

2. The system of claim 1, wherein the first scene data further includes a fourth pose of the autonomous vehicle, relative to the first pose, at a third time before the first time, and the operations further comprising:
determining, based at least in part on the first pose, a fifth pose of the object at the third time, relative to the first pose.

3. The system of claim 1, wherein the representation of the first scene comprises:
a first feature vector identifying the first pose as an origin of a reference frame,
a second feature vector identifying a position and orientation corresponding to the second pose based on the reference frame.

4. The system of claim 3, wherein the first pose is associated with a geographic location and the first feature vector further identifies a classification associated with the geographic location, the classification comprising one of: driving lane, turning lane, road junction, parking spot, traffic light intersection, or shoulder lane.

5. The system of claim 1, wherein the first scene data is associated with the first cluster based at least in part on determining a similarity between the representation and an attribute associated with the first cluster, the attribute being a representation of mean scene data of the first cluster.

6. A method comprising:
receiving a plurality of scene data, each indicating an environment traversed by an autonomous vehicle;
determining a plurality of feature vectors, each representing a scene data of the plurality of scene data;
clustering, based on a distance metric in a space of the feature vectors, the plurality of feature vectors into one or more clusters, each cluster representing a subset of the plurality of scene data;
receiving an instruction to generate a dataset, the instruction including a target size of the dataset, the target size being less than a number of scene data in the plurality of scene data; and
generating, by sub-sampling the one or more clusters, the dataset of the target size,
wherein the sub-sampling selects at least one scene data from the one or more clusters.

7. The method of claim 6, wherein determining the plurality of feature vectors comprises:
inputting respective scene data to a trained, machine-learned (ML) model configured to output a prediction related to the respective scene data;
receiving, from the ML model, an embedding representing the respective scene data,
wherein a feature vector corresponding to the respective scene data comprises the embedding.

8. The method of claim 7, wherein:
the ML model is a transformer-based ML model and the embedding is generated by an encoder component, or
the ML model is a graph neural network (GNN) and the embedding corresponds to a node embedding of the GNN.

9. The method of claim 6, wherein determining a feature vector corresponding to a respective scene data comprises:
determining, based on the respective scene data, a trajectory of the autonomous vehicle;
determining, based on the trajectory, a plurality of spatial bins within an area of the environment covered by the respective scene data,
wherein the feature vector comprises an aggregation of scene labels of the respective scene data within each spatial bin of the plurality of spatial bins.

10. The method of claim 6, wherein determining a feature vector corresponding to a respective scene data comprises:
determining, based on the respective scene data, a first feature vector including scene labels associated with the respective scene data; and
determining, based on the respective scene data, a second feature vector, different from the first feature vector, the second feature vector being represented in a high-dimensional vector space,
wherein the feature vector comprises a combination of the first feature vector and the second feature vector.

11. The method of claim 6, wherein determining a feature vector corresponding to a respective scene data comprises:
determining, based on a reference pose of the autonomous vehicle at a first time, a reference frame for the respective scene data;
determining, based on the reference frame, a first pose corresponding to an object represented in the scene data at the first time;
determining, based on the reference frame, a second pose corresponding to the object at a second time, before the first time;
determining, based on the reference frame, a third pose corresponding to the object at a third time, after the first time,
wherein the feature vector comprises an indication of at least the reference pose, the first pose, the second pose, and the third pose.

12. The method of claim 6, wherein determining a feature vector corresponding to a respective scene data comprises:
determining, for a first object represented in the scene data and based on a reference pose of the first object at a reference time instant, a first reference frame for the first object;
determining, based on the first reference frame, first poses of the first object at first time instances different from the reference time instant;
determining, for a second object represented in the scene data and based on a reference pose of the second object at the reference time instant, a second reference frame for the second object;
determining, based on the second reference frame, second poses of the second object at the first time instances,
wherein the feature vector comprises an indication of at least the first poses and the second poses.

13. The method of claim 6, wherein the sub-sampling selects the scene data from the cluster based on a difficulty level of the scene data.

14. The method of claim 13, wherein determining the difficulty level of the scene data comprises:
receiving, as output from a machine-learned prediction model, a predicted pose of an object represented in the scene data;
determining, based on the scene data, an error between the predicted pose and an actual pose of the object,
wherein the difficulty level is based at least in part on the error.

15. The method of claim 13, wherein the difficulty level is based on a complexity of scene, the complexity indicative of one or more of:
a number of objects in the scene data,
a density of objects in the scene data,
a distance between the autonomous vehicle and an object in the scene,
a map feature in the scene data, or
a speed of the autonomous vehicle or an object in the scene.

16. One or more non-transitory computer-readable media storing processor-executable instructions that, when executed by one or more processors, perform operations comprising:
receiving scene data comprising a plurality of top-down representations of an environment;
determining a plurality of scene features representing the scene data;
clustering, based on a similarity between the scene features, the scene data into one or more clusters, each cluster representing a subset of the plurality of top-down representations;
receiving an instruction to generate a dataset, the instruction indicating criteria of a target dataset;
sampling, based on the criteria of the target dataset, the one or more clusters; and
generating the dataset satisfying the criteria, the dataset comprising a subset of the scene data.

17. The one or more non-transitory computer-readable media of claim 16, wherein each top-down representation associated with a respective time instant, and the scene features include a representation of objects in the environment over a period of time.

18. The one or more non-transitory computer-readable media of claim 16, wherein the scene features comprise an embedding of respective top-down representations generated by a trained machine-learned model configured to output predicted states based on an input top-down representation.

19. The one or more non-transitory computer-readable media of claim 16, wherein the sampling:
comprises selecting a subset of top-down representations from each cluster of the one or more clusters, and
is based on a difficulty level of respective top-down representations.

20. The one or more non-transitory computer-readable media of claim 19, wherein the difficulty level of a top-down representation is based on a prediction error generated by a trained ML model when provided, as input, the top-down representation.
